(19) United States
(12) Patent Application Publication
(10) Pub. No.: US 2026/0005251 A1
(43) Pub. Date: Jan. 1, 2026

(54) SOLVENT FREE BINDER COMPOSITION, ELECTRODE COMPRISING THE SAME AND PREPARATION METHOD OF ELECTRODE

(71) Applicant: UIF (UNIVERSITY INDUSTRY FOUNDATION), YONSEI UNIVERSITY, Seoul (KR)

(72) Inventors: Sang-Young LEE, Seoul (KR); Nag-Young KIM, Seoul (KR)

(73) Assignee: UIF (UNIVERSITY INDUSTRY FOUNDATION), YONSEI UNIVERSITY, Seoul (KR)

(21) Appl. No.: 19/253,378

(22) Filed: Jun. 27, 2025

(30) Foreign Application Priority Data
Jun. 28, 2024 (KR) 10-2024-0085076
Jun. 20, 2025 (KR) 10-2025-0081799

(51) Int. Cl. H01M 4/62; H01M 4/02; H01M 4/1391; H01M 4/48; H01M 10/0525

(52) U.S. Cl. CPC H01M 4/623; H01M 4/1391; H01M 4/483; H01M 4/625; H01M 10/0525; H01M 2004/028

(57) ABSTRACT

The present invention relates to a composition for a solvent-free electrode binder, an electrode comprising the same, and a method for manufacturing the same. The composition for a solvent-free electrode binder according to the present invention can improve mixing uniformity during the electrode mixing process and enhance the interfacial stability between the current collector and the electrode, thereby improving the performance of the electrode and the battery.

### CROSS-REFERENCE TO RELATED APPLICATION

This application claims priority to Korean Patent Application No. 10-2024-0085076 filed on Jun. 28, 2024 and Korean Patent Application No. 10-2025-0081799 filed on Jun. 20, 2025 and all the benefits accruing therefrom under 35 U.S.C. § 119, the contents of which are incorporated by reference in their entirety.

### BACKGROUND

Conventional binder compositions used process solvents (in particular, NMP having a unique molecular structure) to uniformly disperse an active material, a conductive agent, and a binder. However, such process solvents generated a large amount of carbon dioxide (CO₂) during the heat generation process required for drying, excessively increased the cost of heat treatment facilities required for complete drying and recovery, and degraded battery performance due to deterioration of inactive material uniformity within the electrode during the drying process. In addition, existing solid-type solvent-free binders for electrodes had no fluidity or flowability, thus requiring a large amount of energy and time during mixing with electrode materials, making it difficult to induce uniform dispersion. Moreover, due to their nonpolar chemical structure, they exhibited weak adhesion to the current collector, resulting in poor battery performance.

Accordingly, attempts have been made to manufacture electrodes through a dry process without using a solvent in a wet process. However, in the dry process, dispersibility was significantly deteriorated due to the absence of a process solvent, and in addition, there were problems in that the processability was low and the cost was very high.

In addition, polytetrafluoroethylene (PTFE), which is mainly used as a binder for electrodes, has been employed in dry electrode manufacturing processes because, based on the inherent properties of the material, a fibrillation effect occurs, increasing the contact area and enabling the expression of binding force between electrode materials without a solvent. However, the polytetrafluoroethylene (PTFE) required a large amount of energy and time for fibrillation, exhibited low adhesion to the current collector, resulting in low electrode adhesion and degraded battery performance, and had a limitation in that it impaired the powder flowability during the mixing process, thereby negatively affecting the dispersibility of the mixture. In addition, polytetrafluoroethylene (PTFE) is a representative environmental pollutant and is scheduled to be subject to regulatory review, and thus, its replacement is essential.

### SUMMARY

The present invention has been devised to solve the above-mentioned problems, and an object of the present invention is to provide a composition for a solvent-free electrode binder comprising a liquid monomer; and a crosslinking agent.

In addition, another object of the present invention is to provide an electrode composition comprising the composition for a solvent-free electrode binder; and an electrode active material.

In addition, another object of the present invention is to provide an electrode manufactured from the electrode composition.

In addition, another object of the present invention is to provide a battery comprising the electrode.

In addition, another object of the present invention is to provide a device comprising the battery, wherein the device is one selected from the group consisting of a communication device, a transportation device, and an energy storage device.

The objects of the present invention are not limited to the above-mentioned objects, and other objects and advantages of the present invention which are not mentioned can be understood from the following description, and will be more clearly understood by means of the embodiments of the present invention. In addition, it will be easily understood that the objects and advantages of the present invention can be realized by the means and combinations thereof described in the specification.

In one aspect, the present invention provides a composition for a solvent-free electrode binder comprising a liquid monomer; and a crosslinking agent. The liquid monomer may include at least one selected from the group consisting of acrylate-based liquid monomers and acrylamide-based liquid monomers.

The crosslinking agent may include a functional group comprising a double bond. The crosslinking agent may include at least one selected from the group consisting of trimethylolpropane ethoxylate triacrylate (ETPTA), di(trimethylolpropane) tetraacrylate (TMPTA), and poly(ethylene glycol) dioleate (PEGDA).

The liquid monomer and the crosslinking agent may be mixed at a weight ratio of 100:6 to 25.

The composition for the solvent-free electrode binder may further include a thermoplastic polymer binder. The composition for the solvent-free electrode binder may further include polytetrafluoroethylene (PTFE).

In another aspect, the present invention provides an electrode composition comprising the composition for a solvent-free electrode binder; and an electrode active material.

The electrode active material may include at least one selected from the group consisting of lithium cobalt oxide (LiCoO₂), spinel-type lithium manganese oxide (LiMn₂O₄), lithium manganese oxide (LiMnO₂), lithium nickel oxide (LiNiO₂), lithium iron phosphate (LiFePO₄), lithium manganese phosphate (LiMnPO₄), lithium cobalt phosphate (LiCoPO₄), lithium iron pyrophosphate (Li₂FeP₂O₇), lithium niobium oxide (LiNbO₂), lithium iron oxide (LiFeO₂), lithium magnesium oxide (LiMgO₂), lithium copper oxide (LiCuO₂), lithium zinc oxide (LiZnO₂), lithium molybdenum oxide (LiMoO₂), lithium tantalum oxide (LiTaO₂), lithium tungsten oxide (LiWO₂), over-lithiated lithium manganese nickel cobalt composite oxide (xLi₂MnO₃·(1−x)LiMn_{1-y-z}Ni_{y}Co_{z}O₂), lithium nickel cobalt aluminum oxide (LiNi_{0.8}Co_{0.15}Al_{0.05}O₂), lithium nickel manganese oxide (LiNi_{0.5}Mn_{1.5}O₄), and lithium nickel cobalt manganese oxides selected from the group consisting of LiNi_{0.33}Co_{0.33}Mn_{0.33}O₂, LiNi_{0.4}Co_{0.2}Mn_{0.4}O₂, LiNi_{0.5}Co_{0.2}Mn_{0.3}O₂, LiNi_{0.6}Co_{0.2}Mn_{0.2}O₂, LiNi_{0.7}Co_{0.15}Mn_{0.15}O₂, and LiNi_{0.8}Co_{0.1}Mn_{0.1}O₂.

The electrode composition may further comprise a conductive agent. Based on 100 parts by weight of the electrode composition, the composition for a solvent-free electrode binder may be included in an amount of 3 to 20 parts by weight. Another aspect of the present invention provides an electrode manufactured from the electrode composition. Another aspect of the present invention provides a battery comprising the electrode. Another aspect of the present invention provides a device comprising the battery, wherein the device is any one selected from the group consisting of a communication device, a transportation device, and an energy storage device.

In another aspect, the present invention provides a method for manufacturing an electrode, comprising a step of applying and reacting the electrode composition.

The reaction may be performed at 70 to 180° C. and 10 to 30 MPa for 5 to 120 minutes.

The liquid monomer may be N,N-dimethylacrylamide, and the crosslinking agent may be poly(ethylene glycol) dioleate (PEGDA). The liquid monomer and the crosslinking agent may be mixed at a weight ratio of 100:10 to 17. Based on 100 parts by weight of the electrode composition, the composition for the solvent-free electrode binder may be included in an amount of 6 to 10 parts by weight. The reaction may be performed at 85 to 120° C. and 18 to 22 MPa for 20 to 45 minutes.

The means for solving the above problems do not enumerate all the features of the present invention, and may be combined with certain embodiments described in the present specification. Various features of the present invention, and advantages and effects resulting therefrom, will be more clearly understood with reference to the following detailed description.

The composition for a solvent-free electrode binder according to the present invention can improve the mixing uniformity during the electrode mixing process and enhance the interfacial stability between the current collector and the electrode, thereby improving the performance of the electrode and the battery.

In addition to the above-described effects, specific effects of the present invention will be described together with specific details for carrying out the invention below. Furthermore, the effects of the present invention are not limited to the effects mentioned above, and can be readily implemented by the means and combinations thereof described in the specification.

### BRIEF DESCRIPTION OF THE DRAWINGS

FIG. 1 is a schematic view illustrating a manufacturing process of an electrode using a composition for a solvent-free electrode binder according to one embodiment of the present invention.

FIG. 2 shows images of analysis results using an electron probe microanalyzer (EPMA) of cross-sections of electrodes prepared in (a) Comparative Example 1 (PTFE DBE) and (b) Example 1 (Monomer DBE) of the present invention.

FIG. 3 illustrates the electrical resistance of electrodes prepared in Example 1 (Monomer DBE) and Comparative Example 1 (PTFE DBE) of the present invention.

FIG. 4 illustrates the electrochemical impedance spectroscopy (EIS) graphs of electrodes prepared in Example 1 (Monomer DE) and Comparative Example 1 (PTFE DE) of the present invention.

FIG. 5 is a graph showing the interfacial resistance of electrodes prepared in Example 1 (Monomer DBE) and Comparative Example 1 (PTFE DBE) of the present invention.

FIG. 6 shows energy-dispersive X-ray spectroscopy (EDS) graphs of electrodes prepared in (a) Comparative Example 1 (PTFE DBE) and (b) Example 1 (Monomer DBE) of the present invention.

FIG. 7 shows scanning electron microscope (SEM) and energy-dispersive X-ray spectroscopy (EDS) graphs of the C element (a, c) and the N or F element (b, d) of electrodes prepared in (a-b) Example 1 (Monomer DBE) and (c-d) Comparative Example 1 (PTFE DBE) of the present invention.

FIG. 8 shows scanning electron microscope (SEM) images of cross-sections of electrodes prepared in Example 1 (Monomer DBE) and Comparative Example 1 (PTFE DBE) of the present invention.

FIG. 9 shows (a) a galvanostatic intermittent titration technique (GITT) graph, (b) an electrochemical impedance spectroscopy (EIS) analysis graph, (c) a rate capability comparison graph, and (d) a cycle life comparison graph for comparing the initial (after 1st cycle) internal resistance of batteries (half cells) using electrodes prepared in Example 1 (Monomer DBE) and Comparative Example 1 (Conventional DBE) of the present invention.

FIG. 10 shows a graph of internal resistance of batteries (half cells) after 100 charge/discharge cycles, using electrodes prepared in Example 1 (Monomer DBE) and Comparative Example 1 (PTFE DBE) of the present invention.

FIG. 11 shows focused ion beam-scanning electron microscope (FIB-SEM) images of electrodes after 100 cycles in batteries (half cells) using electrodes prepared in Example 1 (Monomer DBE) and Comparative Example 1 (PTFE DBE) of the present invention.

FIG. 12 shows the calculated resistance of the electrode composite layer, measured by applying a probe method (Electrode Resistance Measurement System, HIOKI Co.) to electrodes prepared in Example 2 (Monomer+PTFE DBE) and Comparative Example 2 (PTFE DBE) of the present invention.

FIG. 13 is a graph comparing the rate capability of batteries (half cells) using electrodes prepared in Example 2 (Monomer+PTFE DBE) and Comparative Example 2 (PTFE DBE) of the present invention.

### DETAILED DESCRIPTION OF EMBODIMENTS

In the present specification, the singular expressions include plural expressions unless the context clearly indicates otherwise.

In the present specification, a numerical range expressed using the term “to” is intended to include the values stated before and after the term as the lower and upper limits, respectively. For example, when “a to b” is described in the specification, it shall be understood as meaning “a or more and b or less” (i.e., a to b inclusive).

In the present specification, when multiple numerical values are disclosed as the upper limits and lower limits of a given numerical range, it shall be understood that the range of values disclosed in the specification includes any combination of one of the lower limit values and one of the upper limit values as the lower and upper limits, respectively. For example, when “not less than a” or “not less than b”, and “not more than c” or “not more than d” are described, it shall be understood that the specification discloses the ranges of “a to c”, “a to d”, “b to c”, or “b to d”.

In describing the present invention, detailed descriptions of related known technologies may be omitted when it is determined that such descriptions would unnecessarily obscure the gist of the present invention. In the present specification, unless the terms such as “comprises”, “has”, or “includes” are followed by the expression “only”, it shall be understood that additional elements may be added. Furthermore, the terms “comprise”, “have”, and “include”, and variations thereof, as used herein, are intended to specify the presence of stated features, numbers, steps, components, or combinations thereof, but are not intended to preclude the presence or addition of one or more other features, numbers, steps, components, or combinations thereof. In addition, when a component is expressed in the singular, it shall be understood to include the plural unless specifically stated otherwise.

As described above, conventional binder compositions used process solvents in order to uniformly disperse an active material, a conductive agent, and a binder. However, such process solvents generated a large amount of carbon dioxide (CO₂) during the heat generation process required for drying, excessively increased the cost of heat treatment facilities, and degraded battery performance due to deterioration in the uniformity of inactive materials within the electrode during the drying process. In addition, conventional solid-type solvent-free binders for electrodes required a large amount of energy and time during mixing with electrode materials, made it difficult to induce uniform dispersion, and exhibited poor adhesion to the current collector due to their nonpolar chemical structure, resulting in poor battery performance.

Accordingly, the present invention completely improves the necessity of the drying process and the problems caused thereby by providing a composition for a solvent-free electrode binder that does not use a solvent. More specifically, in one aspect, the present invention provides a composition for a solvent-free electrode binder comprising a liquid monomer; and a crosslinking agent.

The composition for a solvent-free electrode binder of the present invention may exhibit binder properties that contribute not only to maintaining the electrode structure but also to the physical properties and dispersibility of the entire mixture during the mixing process.

The liquid monomer refers to a monomer having flowability and viscosity during electrode fabrication, which enables uniform mixing of the active material and the conductive agent without a solvent, and by using the liquid monomer, it is possible to prepare a composition for a solvent-free electrode binder. Specifically, the liquid monomer may be a monomer having a boiling point of 20 to 250° C. and a melting point of −100 to 200° C.

The liquid monomer may include at least one selected from the group consisting of acrylate-based liquid monomers and acrylamide-based liquid monomers, and more specifically, may include at least one selected from the group consisting of acrylic acid, methyl methacrylate, and N,N-dimethylacrylamide, and preferably, N,N-dimethylacrylamide.

It is preferable, in terms of maximizing interfacial stability, that the liquid monomer includes at least one selected from the group consisting of acrylic acid, methyl methacrylate, and N,N-dimethylacrylamide. In particular, N,N-dimethylacrylamide was confirmed to be especially superior, as it maintained the interfacial resistance transmission at a level equivalent to the initial value without any increase even after 200 cycles, unlike other liquid monomers.

The crosslinking agent may include a functional group capable of forming a crosslinking bond with the liquid monomer.

The functional group capable of forming a crosslinking bond may be a functional group comprising a double bond, and preferably, may include at least one selected from the group consisting of an alkenyl group (—CH═CH—) and an acrylate group (CH₂═CHC(═O)—). More specifically, the crosslinking agent may include at least one selected from the group consisting of acrylate-based compounds, oleate-based compounds, and dioleate-based compounds, and preferably, may include at least one selected from the group consisting of trimethylolpropane ethoxylate triacrylate (ETPTA), di(trimethylolpropane) tetraacrylate (TMPTA), and poly(ethylene glycol) dioleate (PEGDA), and more preferably, may include poly(ethylene glycol) dioleate (PEGDA).

In particular, poly(ethylene glycol) dioleate (PEGDA) is more preferable in that it can increase mechanical flexibility.

The liquid monomer and the crosslinking agent may be mixed at a weight ratio of 100:6 to 25, preferably 100:5 to 23, more preferably 100:7 to 20, and most preferably 100:10 to 17. If the liquid monomer and the crosslinking agent deviate from the above weight ratio such that the liquid monomer is used in excess, the battery capacity and energy may be reduced. Conversely, if the crosslinking agent is used in a smaller amount beyond the above weight ratio, cracking or delamination may occur during the electrode manufacturing process.

In particular, when the liquid monomer and the crosslinking agent are mixed at a weight ratio of 100:10 to 17, it was confirmed that an electrode comprising the same exhibited no deformation, cracking, or wrinkling throughout the electrode even after accelerated durability testing conducted by conventional methods. According to a preferred embodiment of the present invention, the liquid monomer may be N,N-dimethylacrylamide, and the crosslinking agent may be poly(ethylene glycol) dioleate (PEGDA), and when the liquid monomer and the crosslinking agent are used in the combination according to the above-described preferred embodiment, it was confirmed to be particularly preferable in that no deterioration in mechanical properties occurred even after long-term cycling under high-temperature conditions.

The composition for the solvent-free electrode binder may further include a thermoplastic polymer binder.

The composition for the solvent-free electrode binder according to the present invention can be used as a solvent-free system even when it further includes the thermoplastic polymer binder in addition to the above-described liquid monomer and crosslinking agent.

The thermoplastic polymer binder may include at least one selected from the group consisting of polytetrafluoroethylene (PTFE), polystyrene (PS), polyoxymethylene (POM), polymethyl methacrylate (PMMA), cellulose acetate (CA), polychlorotrifluoroethylene (PCTEF), polyvinyl fluoride (PVF), polyvinylidene fluoride (PVDF), polymethylpentene (PMP), polyamide (PA), polycarbonate (PC), polyethylene (PE), polyethylene terephthalate (PET), polyimide (PI), polyphenylene oxide (PPO), polypropylene (PP), polysulfone (PSul), polyvinylidene chloride (PVDC), and polyvinyl chloride (PVC), and preferably, polytetrafluoroethylene (PTFE). In particular, when the composition for a solvent-free electrode binder of the present invention further includes polytetrafluoroethylene (PTFE) as the thermoplastic polymer binder, it was confirmed to be particularly superior in that, in addition to providing ease of electrode fabrication and low electronic resistance due to excellent dispersion, the composition forms a composite with the solvent-free electrode binder of the present invention and does not exhibit any delamination from the current collector, which is typically observed with other thermoplastic polymer binders or PTFE used alone. In another aspect, the present invention provides an electrode composition comprising the composition for a solvent-free electrode binder; and an electrode active material.

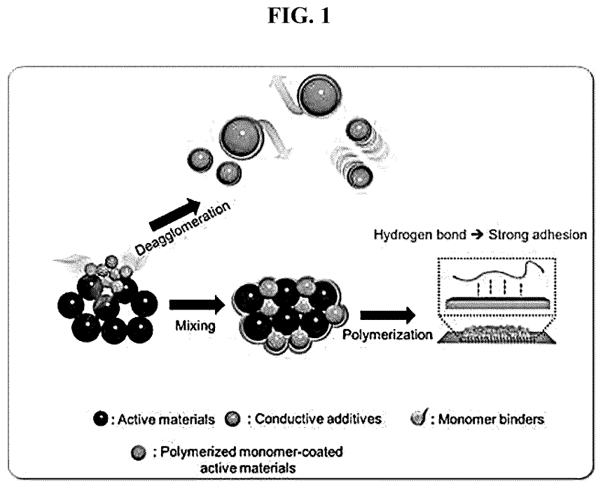

In addition, the composition for a solvent-free electrode binder of the present invention is characterized in that it is mixed with the active material in an unpolymerized state and is subsequently polymerized into a polymer during the electrode formation process, thereby improving the dispersibility of the electrode mixture and enhancing electrode uniformity and cell performance (such as high rate capability and long cycle life). FIG. 1 is a schematic diagram illustrating a process of manufacturing an electrode using a composition for a solvent-free electrode binder according to one embodiment of the present invention. As shown in FIG. 1, the composition for a solvent-free electrode binder according to one embodiment of the present invention exhibits significantly higher fluidity and flowability compared to solid-type binders, which remarkably increases contact opportunities with the active material and conductive agent. In addition, aggregation of particles can be significantly reduced due to the chemical structure and electrostatic repulsion of the solvent-free electrode binder composition.

The electrode active material may be a conventional cathode active material, and, as a non-limiting example, may include lithium cobalt oxide (LiCoO₂), spinel-type lithium manganese oxide (LiMn₂O₄), lithium manganese oxide (LiMnO₂), lithium nickel oxide (LiNiO₂), lithium iron phosphate (LiFePO₄), lithium manganese phosphate (LiMnPO₄), lithium cobalt phosphate (LiCoPO₄), lithium iron pyrophosphate (Li₂FeP₂O₇), lithium niobium oxide (LiNbO₂), lithium iron oxide (LiFeO₂), lithium magnesium oxide (LiMgO₂), lithium copper oxide (LiCuO₂), lithium zinc oxide (LiZnO₂), lithium molybdenum oxide (LiMoO₂), lithium tantalum oxide (LiTaO₂), lithium tungsten oxide (LiWO₂), over-lithiated lithium manganese nickel cobalt composite oxide (xLi₂MnO₃·(1−x)LiMn_{1-y-z}Ni_{y}Co_{z}O₂), lithium nickel cobalt aluminum oxide (LiNi_{0.8}Co_{0.15}Al_{0.05}O₂), lithium nickel manganese oxide (LiNi_{0.5}Mn_{1.5}O₄), and lithium nickel cobalt manganese oxides such as LiNi_{0.33}Co_{0.33}Mn_{0.33}O₂, LiNi_{0.4}Co_{0.2}Mn_{0.4}O₂, LiNi_{0.5}Co_{0.2}Mn_{0.3}O₂, LiNi_{0.6}Co_{0.2}Mn_{0.2}O₂, LiNi_{0.7}Co_{0.15}Mn_{0.15}O₂, and LiNi_{0.8}Co_{0.1}Mn_{0.1}O₂, but is not limited thereto.

The electrode composition may further include a conductive agent. The conductive agent is not particularly limited as long as it is conventionally used in the relevant technical field, but as a non-limiting example, it may be a carbon-based conductive agent. The carbon-based conductive agent may include particulate carbon-based conductive agents, fibrous carbon-based conductive agents, plate-shaped carbon-based conductive agents, or mixtures thereof. Examples of the particulate carbon-based conductive agent include acetylene black, Ketjen black, channel black, furnace black, lamp black, thermal black, and carbon black. Examples of the fibrous carbon-based conductive agent include carbon nanotubes and conductive carbon fibers. Examples of the plate-shaped carbon-based conductive agent include graphene (including GRO).

Based on 100 parts by weight of the electrode composition, the composition for the solvent-free electrode binder may be included in an amount of 3 to 20 parts by weight, 4 to 15 parts by weight, more preferably 5 to 13 parts by weight, and most preferably 6 to 10 parts by weight. If the composition for the solvent-free electrode binder is included in an amount less than the lower limit, electrode fabrication may be impossible or delamination may occur. Conversely, if it is used in an amount exceeding the upper limit, the battery capacity may be reduced.

In the electrode composition, based on 100 parts by weight of the composition for the solvent-free electrode binder, the conductive agent may be included in an amount of 30 to 55 parts by weight, 35 to 50 parts by weight, more preferably 38 to 47 parts by weight, and most preferably 40 to 45 parts by weight.

If the content of the conductive agent is less than the lower limit, the ion and charge transfer properties may be degraded, and thus, it is preferable to satisfy the above range. In another aspect, the present invention provides an electrode manufactured from the electrode composition. In another aspect, the present invention provides a battery comprising the electrode. The battery may include at least one selected from the group consisting of a lithium secondary battery, a lithium-ion battery, a lithium metal battery, and a sodium-ion secondary battery. In another aspect, the present invention provides a device comprising the battery, wherein the device is one selected from the group consisting of a communication device, a transportation device, and an energy storage device. In another aspect, the present invention provides a method for manufacturing an electrode, comprising a step of applying and reacting the electrode composition.

The electrode composition may be applied onto a current collector. The reaction may be performed at 70 to 180° C. and 10 to 30 MPa for 5 to 120 minutes, preferably at 75 to 150° C. and 13 to 27 MPa for 10 to 60 minutes, more preferably at 80 to 140° C. and 15 to 25 MPa for 15 to 50 minutes, and most preferably at 85 to 120° C. and 18 to 22 MPa for 20 to 45 minutes.

If any one of the reaction temperature, pressure, or time is less than the lower limit, resistance may increase due to unreacted residual crosslinking compounds. Conversely, if it exceeds the upper limit, there may be a problem of damage to the active material.

According to the most preferred embodiment of the present invention,
(1) the liquid monomer is N,N-dimethylacrylamide,
(2) the crosslinking agent is poly(ethylene glycol) dioleate (PEGDA),
(3) the liquid monomer and the crosslinking agent are mixed at a weight ratio of 100:10 to 17,
(4) based on 100 parts by weight of the electrode composition, the composition for the solvent-free electrode binder is included in an amount of 6 to 10 parts by weight, and
(5) the reaction may be performed at 85 to 120° C. and 18 to 22 MPa for 20 to 45 minutes.

When the method for manufacturing an electrode according to the present invention satisfies all of the above conditions (1) to (5), no aggregation of the binder or loss thereof was observed in the electrode even after 300 charge/discharge cycles, and the electrochemical performance was maintained at a level equivalent to the initial state, which was particularly preferable. However, when any one of the conditions (1) to (5) was not satisfied, aggregation or loss of the binder in the electrode was observed starting from around 200 cycles, and the electrochemical performance after 300 cycles was found to be somewhat degraded compared to the initial performance.

Hereinafter, the present invention will be described in more detail with reference to examples and the like; however, the scope and content of the present invention shall not be construed as being reduced or limited by the following examples and the like.

### Example 1. Monomer DBE

A composition for a solvent-free electrode binder was prepared by mixing N,N-dimethylacrylamide and poly(ethylene glycol) dioleate (PEGDA) at a weight ratio of 100:14.

A solvent-free dry slurry was prepared by mixing an electrode active material (lithium metal oxide), a conductive agent (carbon black), and the composition for a solvent-free electrode binder at a weight ratio of 90:3:7. Then, the solvent-free dry slurry was applied onto a current collector, and a cathode was manufactured through a hot-pressing process at 90° C. and a pressure of 20 MPa for 30 minutes.

### Example 2. Monomer DBE+PTFE

A composition for a solvent-free electrode binder was prepared by mixing N,N-dimethylacrylamide and poly(ethylene glycol) dioleate (PEGDA) at a weight ratio of 100:14. Thereafter, the composition for the solvent-free electrode binder was further mixed with PTFE at a mass ratio of 1:1 to prepare a final composition for a solvent-free electrode binder.

An electrode active material (lithium metal oxide), a conductive agent (carbon black), and the final composition for the solvent-free electrode binder were mixed and kneaded at a weight ratio of 96:2:2, and then a cathode was manufactured by a hot-pressing process at 90° C. on a current collector. At this time, the areal mass loading of the electrode was set to 40 mg/cm².

### Comparative Example 1. PTFE DBE

An electrode active material (lithium metal oxide), a conductive agent (carbon black), and a binder (PTFE) were mixed and kneaded at a weight ratio of 90:3:7, and then a cathode was manufactured by a hot-pressing process at 90° C. on a current collector.

### Comparative Example 2. PTFE DBE

An electrode active material (lithium metal oxide), a conductive agent (carbon black), and a binder (PTFE) were mixed and kneaded at a weight ratio of 96:2:2, and then a cathode was manufactured by a hot-pressing process at 90° C. on a current collector. At this time, the areal mass loading of the electrode was set to 40 mg/cm².

### Experimental Example 1. Observation of Electrode Surface

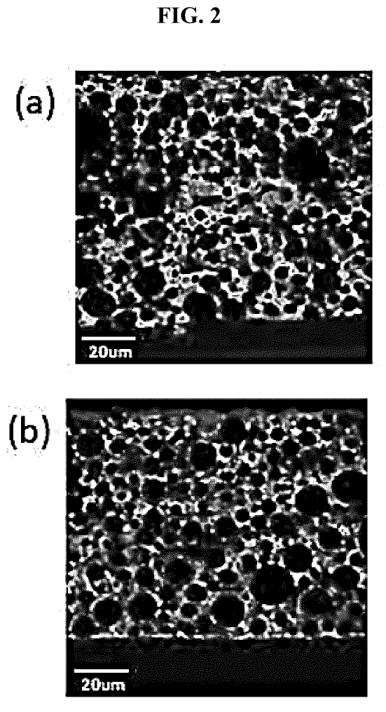

FIG. 2 shows images of analysis results using an electron probe microanalyzer (EPMA) for the cross-sections of electrodes prepared in (a) Comparative Example 1 (PTFE DBE) and (b) Example 1 (Monomer DBE) of the present invention.

As shown in FIG. 2, the PTFE electrode prepared in Comparative Example 1 exhibited a non-uniform electronic conductivity distribution with red and blue regions, whereas the Monomer DBE prepared in Example 1 exhibited a uniform electronic conductivity distribution in blue.

### Experimental Example 2. Comparison of Resistance

### Electronic Resistance

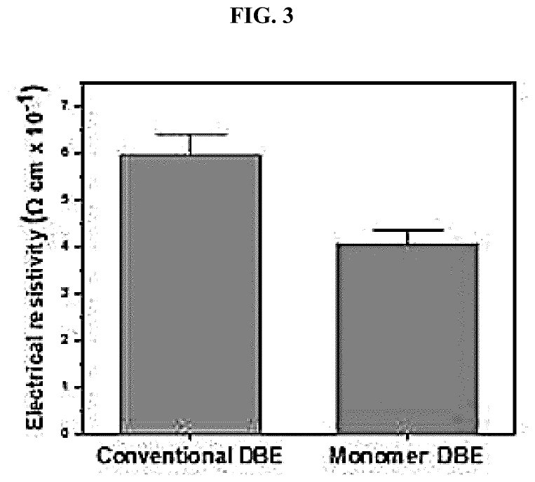

FIG. 3 shows the electronic resistance of electrodes prepared in Example 1 (Monomer DBE) and Comparative Example 1 (PTFE DBE) of the present invention. As shown in FIG. 3, the electronic resistance of the electrodes was 4.06 Ω·cm×10⁻¹ for Example 1 (Monomer DBE) and 5.98 Ω·cm×10⁻¹ for Comparative Example 1 (PTFE DBE), indicating that the electrode electronic resistance could be significantly reduced in Example 1.

### Ion Transfer Resistance

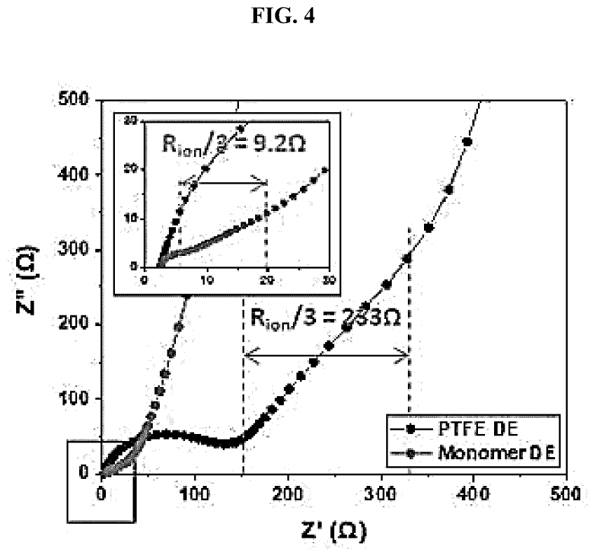

Ion transfer resistance (Rₐᵢₒₙ) was measured using electrochemical impedance spectroscopy (EIS) with a symmetric cell, and the results are shown in FIG. 4.

FIG. 4 shows electrochemical impedance spectroscopy (EIS) graphs of electrodes prepared in Example 1 (Monomer DE) and Comparative Example 1 (PTFE DE) of the present invention.

As shown in FIG. 4, the ion transfer resistance corresponding to the 45-degree sloped region following the semicircle was 253Ω for Comparative Example 1 (PTFE DE), whereas it was significantly lower at 9.2Ω for Example 1 (Monomer DE).

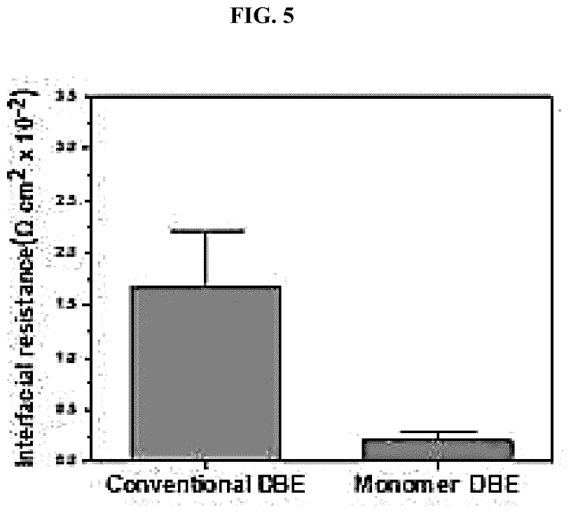

FIG. 5 is a graph showing the interfacial resistance of electrodes prepared in Example 1 (Monomer DBE) and Comparative Example 1 (PTFE DBE) of the present invention. As shown in FIG. 5, the interfacial resistance of the electrodes prepared in Example 1 (Monomer DE) and Comparative Example 1 (PTFE DE) was 0.0168 Ω/cm² and 0.0022 Ω/cm², respectively, indicating that the dry electrode using a liquid monomer according to one embodiment of the present invention exhibited low interfacial resistance.

### Resistance of Electrode Composite Layer

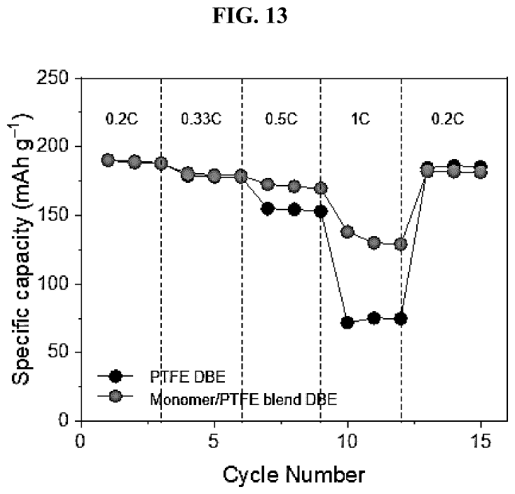

FIG. 12 shows the calculated resistance of the electrode composite layer by applying a probe method (Electrode Resistance Measurement System, HIOKI Co.) to electrodes prepared in Example 2 (Monomer+PTFE DE) and Comparative Example 2 (PTFE DE) of the present invention.

Specifically, resistance was calculated by bringing a probe from HIOKI Co. into contact with the electrode, applying a constant current, and measuring the potential. In this process, a constant current of 50 mA was applied while the potential was measured to calculate the resistance.

The electrode composite layer resistance of the electrodes prepared in Example 2 (Monomer+PTFE DE) and Comparative Example 2 (PTFE DE) was 0.64 Ω/cm and 0.86 Ω/cm, respectively, indicating that the dry electrode using the monomer and PTFE according to one embodiment of the present invention exhibited lower electrode composite layer resistance.

### Experimental Example 3

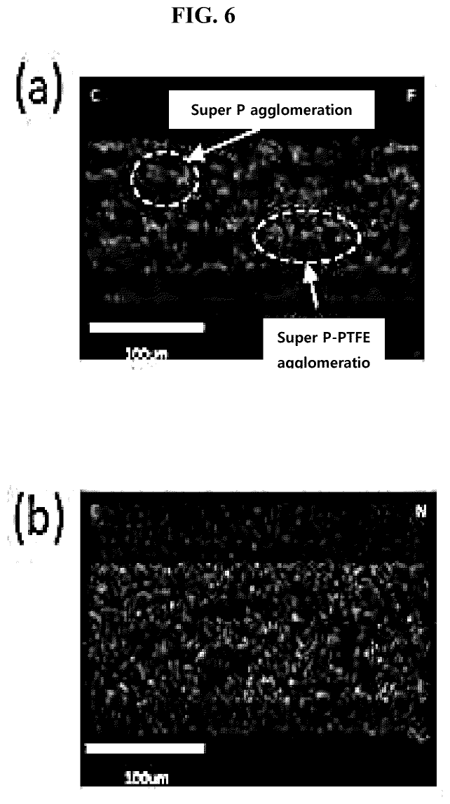

FIG. 6 shows energy-dispersive X-ray spectroscopy (EDS) graphs of electrodes prepared in (a) Comparative Example 1 (PTFE DBE) and (b) Example 1 (Monomer DBE) of the present invention. In the graphs, red indicates the C element, and green indicates the F element.

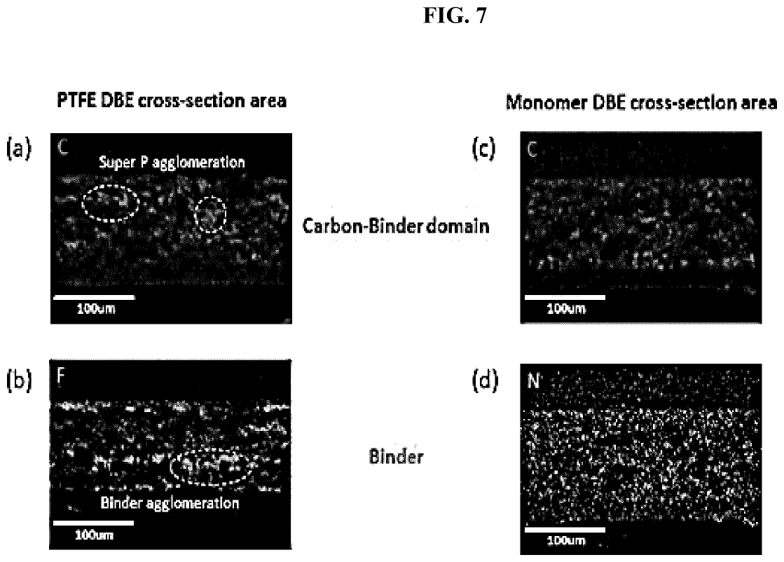

FIG. 7 shows scanning electron microscope (SEM) and energy-dispersive X-ray spectroscopy (EDS) graphs of the C element (a, c) and the N or F element (b, d) of electrodes prepared in (a-b) Example 1 (Monomer DBE) and (c-d) Comparative Example 1 (PTFE DBE) of the present invention.

As shown in FIG. 7, in the electrode prepared in Comparative Example 1, the conductive agent of the PTFE dry electrode was not dispersed on the surface of the active material, but rather bound within the PTFE binder. In contrast, in the electrode prepared in Example 1 (Monomer DBE), it was confirmed that the conductive agent, binder, and carbon were more uniformly dispersed.

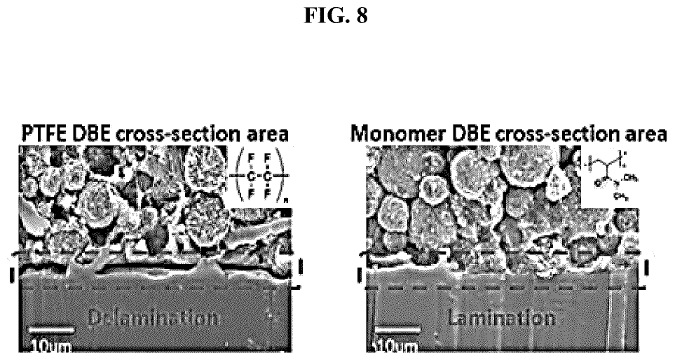

FIG. 8 shows scanning electron microscope (SEM) images of the cross-sections of electrodes prepared in Example 1 (Monomer DBE) and Comparative Example 1 (PTFE DBE) of the present invention. As shown in FIG. 8, in the electrode prepared in Comparative Example 1 (PTFE DBE), a delamination phenomenon was observed in which a thin layer separated between the current collector and the coating layer. In contrast, in the electrode prepared in Example 1 (Monomer DBE), the coating layer was very well laminated without any delamination.

### Experimental Example 4

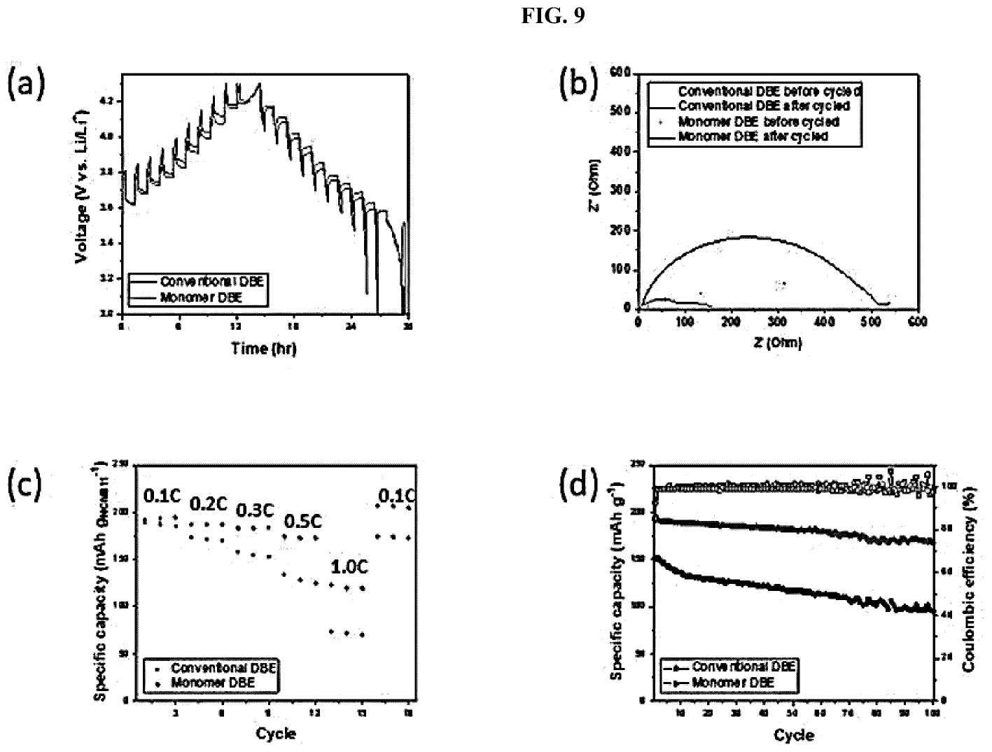

FIG. 9 shows (a) a galvanostatic intermittent titration technique (GITT) graph, (b) an electrochemical impedance spectroscopy (EIS) analysis graph, (c) a rate capability comparison graph, and (d) a cycle life comparison graph for comparing the initial (after the 1st cycle) internal resistance of batteries (half cells) using electrodes prepared in Example 1 (Monomer DBE) and Comparative Example 1 (PTFE DBE) of the present invention.

As shown in FIG. 9, Example 1 (Monomer DBE) exhibited lower overpotential ((a) of FIG. 9) and impedance resistance ((b) of FIG. 9) compared to Comparative Example 1 (PTFE DBE). In addition, Example 1 (Monomer DBE) demonstrated superior rate capability ((c) of FIG. 9) due to lower resistance than Comparative Example 1 (PTFE DBE), and it was confirmed to exhibit excellent cycle life characteristics attributable to low resistance and strong adhesion.

### Experimental Example 5

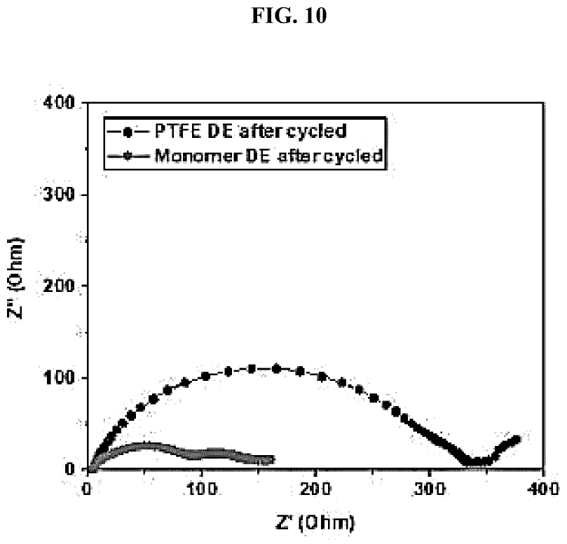

FIG. 10 shows the internal resistance graph of batteries (half cells) using electrodes prepared in Example 1 (Monomer DBE) and Comparative Example 1 (PTFE DBE) after 100 charge/discharge cycles.

As shown in FIG. 10, the electrode prepared in Example 1 (Monomer DBE) exhibited lower impedance resistance after charge/discharge cycles compared to Comparative Example 1 (PTFE DBE), which is attributable to a superior electron/ion network and lower resistance.

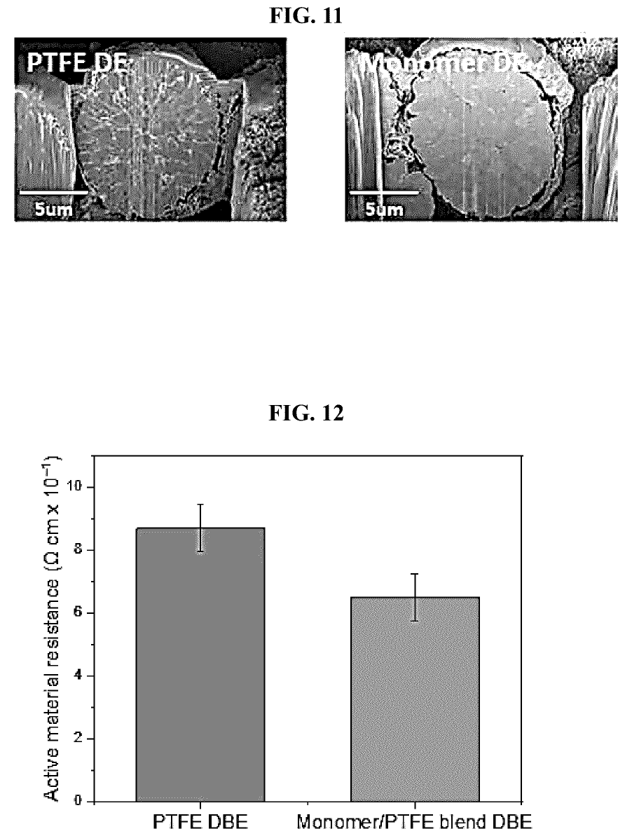

FIG. 11 shows focused ion beam-scanning electron microscope (FIB-SEM) images of electrodes after 100 cycles in batteries (half cells) using electrodes prepared in Example 1 (Monomer DBE) and Comparative Example 1 (PTFE DBE) of the present invention.

As shown in FIG. 11, it can be seen that, compared to Comparative Example 1 (PTFE DBE), almost no active material fracture occurred in Example 1 (Monomer DBE) due to uniform electrochemical reactions.

### Experimental Example 6

FIG. 13 is a graph comparing the rate capability of batteries (half cells) using electrodes prepared in Example 2 (Monomer+PTFE DBE) and Comparative Example 2 (PTFE DBE) of the present invention. (Electrolyte condition: 1M LiPF₆ in EC/EMC (3/7, v/v)+10 wt % FEC+2 wt % VC)

As shown in FIG. 13, it was confirmed that Example 2 (Monomer+PTFE DBE) exhibited superior rate capability compared to Comparative Example 2 (PTFE DBE).

The features described in the above-described embodiment may be combined with other embodiments unless explicitly stated otherwise. Although the preferred embodiments of the present invention have been described in detail above, the scope of the present invention is not limited thereto, and various modifications and improvements by those skilled in the art based on the basic concept defined in the following claims also fall within the scope of the present invention.

What is claimed is:

1. A composition for a solvent-free electrode binder comprising:
a liquid monomer; and
a crosslinking agent.

2. The composition for a solvent-free electrode binder according to claim 1,
wherein the liquid monomer comprises at least one selected from the group consisting of acrylate-based liquid monomers and acrylamide-based liquid monomers.

3. The composition for a solvent-free electrode binder according to claim 1,
wherein the crosslinking agent comprises a functional group comprising a double bond.

4. The composition for a solvent-free electrode binder according to claim 1,
wherein the crosslinking agent comprises at least one selected from the group consisting of trimethylolpropane ethoxylate triacrylate (ETPTA), di(trimethylolpropane) tetraacrylate (TMPTA), and poly(ethylene glycol) dioleate (PEGDA).

5. The composition for a solvent-free electrode binder according to claim 1,
wherein the liquid monomer and the crosslinking agent are mixed in a weight ratio of 100:6 to 25.

6. The composition for a solvent-free electrode binder according to claim 1,
further comprising a thermoplastic polymer binder.

7. The composition for a solvent-free electrode binder according to claim 1,
further comprising polytetrafluoroethylene (PTFE).

8. An electrode composition comprising:
the composition for a solvent-free electrode binder according to any one of claim 1; and
an electrode active material.

9. The electrode composition according to claim 8,
wherein the electrode active material comprises at least one selected from the group consisting of lithium cobalt oxide (LiCoO₂), spinel-type lithium manganese oxide (LiMn₂O₄), lithium manganese oxide (LiMnO₂), lithium nickel oxide (LiNiO₂), lithium iron phosphate (LiFePO₄), lithium manganese phosphate (LiMnPO₄), lithium cobalt phosphate (LiCoPO₄), lithium iron pyrophosphate (Li₂FeP₂O₇), lithium niobium oxide (LiNbO₂), lithium iron oxide (LiFeO₂), lithium magnesium oxide (LiMgO₂), lithium copper oxide (LiCuO₂), lithium zinc oxide (LiZnO₂), lithium molybdenum oxide (LiMoO₂), lithium tantalum oxide (LiTaO₂), lithium tungsten oxide (LiWO₂), over-lithiated lithium manganese nickel cobalt composite oxide (xLi₂MnO₃·(1−x)LiMn_{1-y-z}Ni_{y}Co_{z}O₂), lithium nickel cobalt aluminum oxide (LiNi_{0.8}Co_{0.15}Al_{0.05}O₂), lithium nickel manganese oxide (LiNi_{0.5}Mn_{1.5}O₄), and lithium nickel cobalt manganese composite oxides including LiNi_{0.33}Co_{0.33}Mn_{0.33}O₂, LiNi_{0.4}Co_{0.2}Mn_{0.4}O₂, LiNi_{0.5}Co_{0.2}Mn_{0.3}O₂, LiNi_{0.6}Co_{0.2}Mn_{0.2}O₂, LiNi_{0.7}Co_{0.15}Mn_{0.15}O₂, and LiNi_{0.8}Co_{0.1}Mn_{0.1}O₂.

10. The electrode composition according to claim 8,
further comprising a conductive agent.

11. The electrode composition according to claim 8,
wherein, based on 100 parts by weight of the electrode composition, the composition for the solvent-free electrode binder is included in an amount of 3 to 20 parts by weight.

12. An electrode comprising the electrode composition according to claim 8.

13. A battery comprising the electrode according to claim 12.

14. A device comprising the battery according to claim 13,
wherein the device is any one selected from the group consisting of a communication device, a transportation device, and an energy storage device.

15. A method for manufacturing an electrode,
comprising the step of applying and reacting the electrode composition according to claim 8.

16. The method for manufacturing an electrode according to claim 15,
wherein the reaction is performed at 70 to 180° C. and 10 to 30 MPa for 5 to 120 minutes.

17. The method for manufacturing an electrode according to claim 15,
wherein the liquid monomer is N,N-dimethylacrylamide, the crosslinking agent is poly(ethylene glycol) dioleate (PEGDA),
the liquid monomer and the crosslinking agent are mixed at a weight ratio of 100:10 to 17,
based on 100 parts by weight of the electrode composition, the composition for the solvent-free electrode binder is included in an amount of 6 to 10 parts by weight, and
the reaction is performed at 85 to 120° C. and 18 to 22 MPa for 20 to 45 minutes.
